(19) United States
(12) Patent Application Publication
(10) Pub. No.: US 2019/0112840 A1
(43) Pub. Date: Apr. 18, 2019

(54) ATTACHMENT LOCK

(71) Applicant: Sinox Co., Ltd., New Taipei City (TW)

(72) Inventor: Chun-Sheng Wu, New Taipei City (TW)

(21) Appl. No.: 15/927,839

(22) Filed: Mar. 21, 2018

(30) Foreign Application Priority Data
Oct. 16, 2017 (TW) 106215165

(51) Int. Cl. E05B 73/00

(52) U.S. Cl. CPC E05B 73/0082; E05B 73/0005

(57) ABSTRACT

An attachment lock is connected with a coupling orifice of a portable device, a size of a cross section of an accommodation chamber of the coupling orifice is more than an opening of the coupling orifice. The attachment lock contains: a body, a fastener, and a lock mechanism. The fastener includes a pair of locking parts movably connected in the body and changeably inserted into the coupling orifice via the opening of the coupling orifice so as to retract. Furthermore, the pair of locking parts are changeably connected in the coupling orifice so as to expand after moving into the coupling orifice. The pair of locking parts respectively include a first contacting portion and a second contacting portion which have a first arcuation edge and a second arcuation edge individually. The lock mechanism is configured to lock the fastener, when the pair of locking parts changeably expand.

### FIELD OF THE INVENTION

The present invention relates to a lock which is connected with a coupling orifice of a portable device, and more particularly to an attachment lock which is configured to lock in a coupling orifice in a trapezoid shape or in a protrusion shape.

### BACKGROUND OF THE INVENTION

A portable device (such as a laptop) is in a small size and is expensive, and it is easy to be stolen because of high price and sales convenience. To overcome such a problem, the portable device has a rectangular coupling orifice configured to lock with an attachment head of a lock, thus obtaining safety. However, when the rectangular coupling orifice is connected with the lock, it is not secure enough to avoid damage of the rectangular coupling orifice.

The present invention has arisen to mitigate and/or obviate the afore-described disadvantages.

### SUMMARY OF THE INVENTION

The primary aspect of the present invention is to provide an attachment lock which is connected in the coupling orifice securely.

To obtain above-mentioned aspect, a lock provided by the present invention is connected with a coupling orifice of a portable device, and more particularly to an attachment lock which is configured to lock in a coupling orifice formed in a trapezoid shape or in a protrusion shape.

The attachment lock is connected with a coupling orifice of a portable device, a size of a cross section of an accommodation chamber of the coupling orifice is more than an opening of the coupling orifice, and the attachment lock contains: a body, a fastener connected in the body and configured to couple in the coupling orifice, and a lock mechanism arranged on the body.

The fastener includes a pair of locking parts movably connected in an end of the body, the pair of locking parts are changeably inserted into the accommodation chamber via the opening of the coupling orifice so as to retract, and the pair of locking parts are changeably connected in the coupling orifice so as to expand after moving into the coupling orifice, wherein the pair of locking parts respectively include a first contacting portion and a second contacting portion which are configured to contact with a peripheral wall of the accommodation chamber, and the first contacting portion and the second contacting portion have a first arcuation edge and a second arcuation edge individually; wherein the lock mechanism is configured to lock the fastener, when the pair of locking parts changeably expand.

Thereby, the pair of locking parts changeably retract and insert into the accommodation chamber from the opening of the coupling orifice which is narrower than the accommodation chamber so that the pair of locking parts are locked in the coupling orifice by using the lock mechanism.

Preferably, the accommodation chamber is a trapezoidal space or a rectangular space.

Preferably, the first arcuation edge and the second arcuation edge have a first arcuate surface and a second arcuate surface respectively, wherein when the pair of locking parts move into the coupling orifice so as to be locked, at least one linear contact forms among the first arcuate surface of the first arcuation edge, the second arcuate surface of the second arcuation edge, and the peripheral wall of the accommodation chamber.

Preferably, the pair of locking parts are rotatably coupled in the body.

Preferably, the lock mechanism includes an abutting post configured to abut against and to expand the pair of locking parts.

Preferably, the lock mechanism is a key lock mechanism or a combination lock mechanism.

### BRIEF DESCRIPTION OF THE DRAWINGS

FIG. 1 is a perspective view of an attachment lock according to a preferred embodiment of the present invention.

FIG. 2 is a cross-sectional perspective view of the attachment lock according to the preferred embodiment of the present invention.

FIG. 3 is an amplified view of a part of FIG. 2.

FIG. 4A-4C are a cross sectional view showing the operation of the attachment lock according to the preferred embodiment of the present invention.

FIG. 5A-5C are a cross sectional view showing the attachment lock being connected with a coupling orifice according to the preferred embodiment of the present invention.

### DETAILED DESCRIPTION OF THE PREFERRED EMBODIMENTS

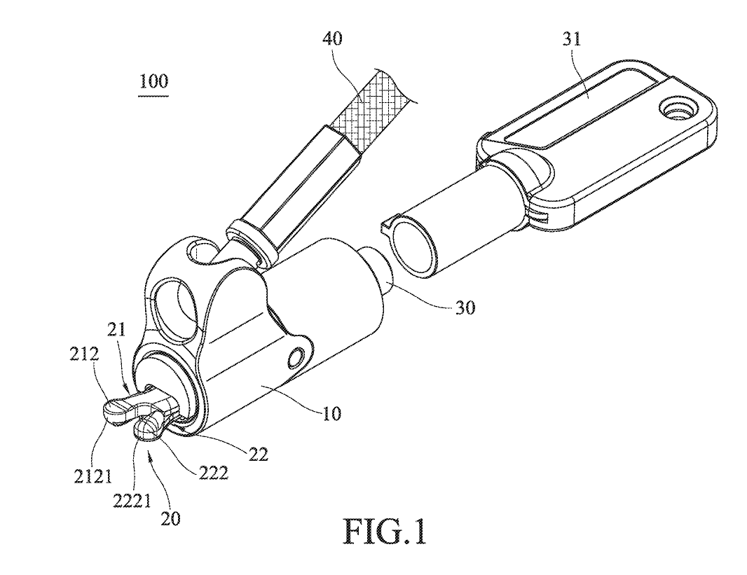

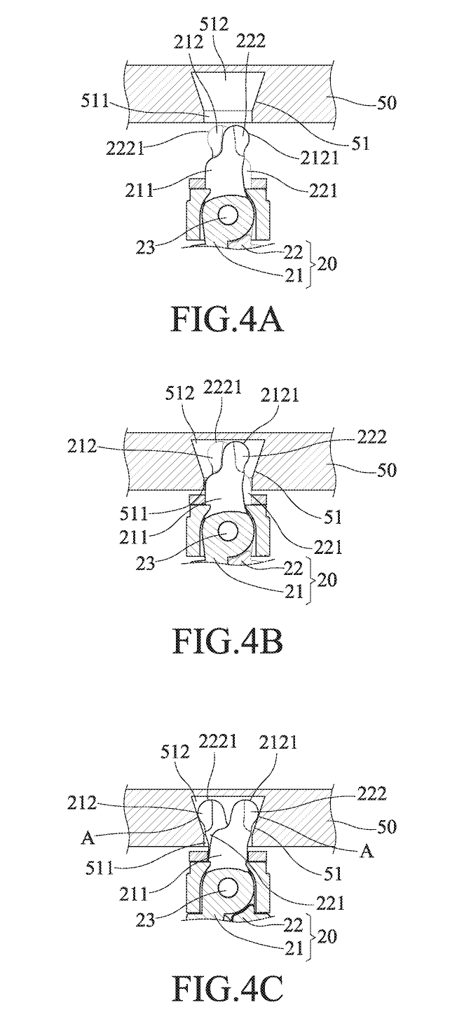

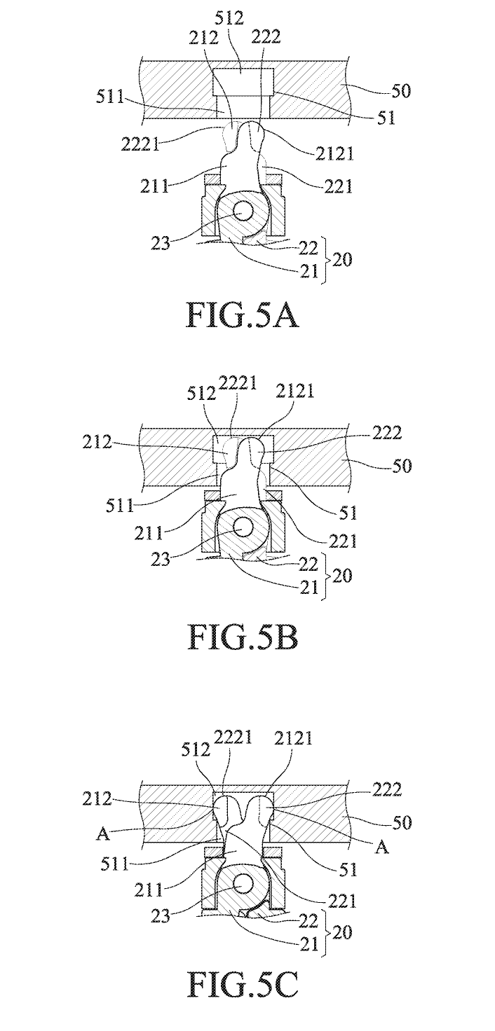

With reference to FIGS. 1-3, an attachment lock 100 according to a preferred embodiment of the present invention is connected with a coupling orifice 51 of a portable device 50 (as shown in FIGS. 4A and 5A), wherein a size of a cross section of an accommodation chamber 512 of the coupling orifice 51 is more than an opening 511 of the coupling orifice 51, for example, the accommodation chamber 512 is a trapezoidal space so as to form the coupling orifice 51 in a trapezoid shape or the accommodation chamber 512 is a rectangular space so as to form the coupling orifice 51 in a protrusion shape.

The attachment lock 100 comprises a body 10, a fastener 20 connected in an end of the body 10, and a lock mechanism 30 arranged on the body 10, wherein the body 10 is configured to connect with a connection element 40 (such as a chain or a cable) so as to be fixed on an object.

The fastener 20 includes a pair of locking parts 21, 22 or other moving parts which are movably connected in the end of the body 10, wherein the pair of locking parts 21, 22 are rotatably coupled in the body 10 by way of a joining element 23 and expose outside the body 10, wherein the pair of locking parts 21, 22 changeably rotate relative to the body 10 so as to move close to or away from each other, thus retracting the fastener 20 (as shown in FIGS. 4A and 5A) or expanding the fastener 20 (as illustrated in FIGS. 4C and 5C) outward.

The pair of locking parts 21, 22 include a first contacting portion 211 and a second contacting portion 221 respectively, the first contacting portion 211 and the second contacting portion 221 have a first arcuation edge 212 and a second arcuation edge 222 individually, and the first arcuation edge 212 and the second arcuation edge 222 have a first arcuate surface 2121 and a second arcuate surface 2221 respectively.

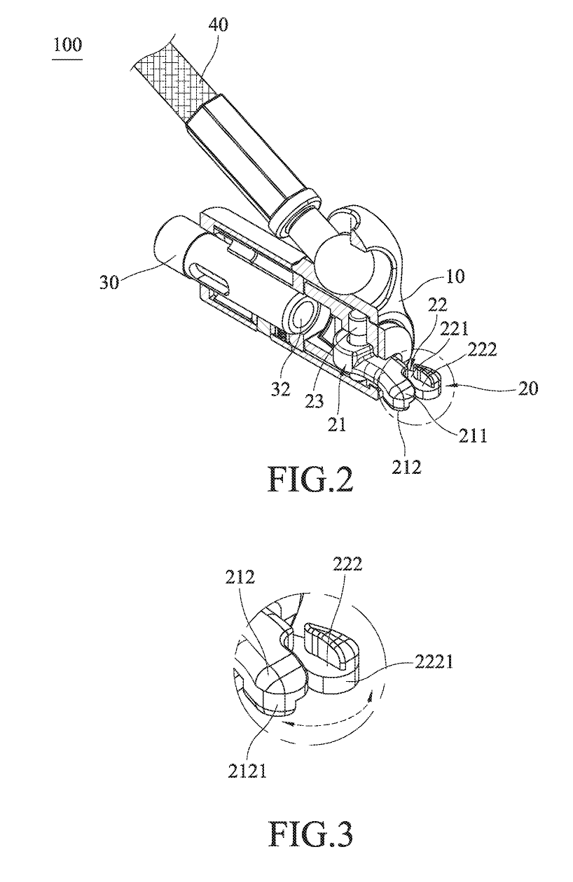

The lock mechanism 30 is arranged on the body 10, in operation, the body 10 is a key lock which is driven by a key 31, as shown in FIGS. 1-2. Alternatively, the body 10 is driven by a combination lock which is set by secret codes or is driven by other lock mechanisms. The lock mechanism 30 includes an abutting post 32 configured to abut against and to expand the pair of locking parts 21, 22. For example, when the pair of locking parts 21, 22 are changeably expanded, the abutting post 32 is controlled to lock the fastener 20 so that the pair of locking parts 21, 22 are not changeably expanded any more, thus retracting the pair of locking parts 21, 22.

Referring to FIGS. 4A-4C, the attachment lock 100 is operable continuously, wherein the coupling orifice 51 has the accommodation chamber 512 which is the trapezoidal space so that the coupling orifice 51 is in the trapezoid shape.

In application, the attachment lock 100 is connected with the coupling orifice 51 of the portable device 50 as following description.

When the fastener 20 is not locked by the lock mechanism 30, the pair of locking parts 21, 22 are changeably retracted so as to insert into the accommodation chamber 512 via the opening 511 of the coupling orifice 51. After the pair of locking parts 21, 22 insert into the accommodation chamber 512, the lock mechanism 30 drives the abutting post 32 to movably abut against and lock the pair of locking parts 21, 22, such that the pair of locking parts 21, 22 move away from each other so as to expand outward. In the meantime, the first arcuation edge 212 of the first contacting portion 211 and the second arcuation edge 222 of the second contacting portion 221 contact with a peripheral wall of the accommodation chamber 512 so that at least one linear contact A forms among the first arcuate surface 2121 of the first arcuation edge 212, the second arcuate surface 2221 of the second arcuation edge 222, and the peripheral wall of the accommodation chamber 512, thus connecting the attachment lock 100 with the coupling orifice 51.

As shown in FIGS. 5A-5C, the attachment lock 100 is operable continuously, wherein the coupling orifice 51 has the accommodation chamber 512 which is the trapezoidal space so as to form the coupling orifice 51 in the trapezoid shape.

The attachment lock 100 is connected with the coupling orifice 51 of the portable device 50 based on above-mentioned operation, so further remarks are omitted.

As desiring to unlock the coupling orifice 51, the lock mechanism 30 is operated so that after the abutting post 32 moves or is moved to a retracting position, the attachment lock 100 is detachable from the coupling orifice 51 so as to remove the portable device 50.

Thereby, the attachment lock 100 is connected with the coupling orifice 51 of the portable device 50 and is further fixed in the accommodation chamber 512, the size of the cross section of which is more than the opening 511 of the coupling orifice 51.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An attachment lock being connected with a coupling orifice of a portable device, a size of a cross section of an accommodation chamber of the coupling orifice being more than an opening of the coupling orifice, and the attachment lock comprising: a body, a fastener connected in the body and configured to couple in the coupling orifice, and a lock mechanism arranged on the body;
wherein the fastener includes a pair of locking parts movably connected in an end of the body, the pair of locking parts are changeably inserted into the accommodation chamber via the opening of the coupling orifice so as to retract, and the pair of locking parts are changeably connected in the coupling orifice so as to expand after moving into the coupling orifice, wherein the pair of locking parts respectively include a first contacting portion and a second contacting portion which are configured to contact with a peripheral wall of the accommodation chamber, and the first contacting portion and the second contacting portion have a first arcuation edge and a second arcuation edge individually; and
wherein the lock mechanism is configured to lock the fastener, when the pair of locking parts changeably expand.

2. The attachment lock as claimed in claim 1, wherein the accommodation chamber is a trapezoidal space.

3. The attachment lock as claimed in claim 1, wherein the accommodation chamber is a rectangular space.

4. The attachment lock as claimed in claim 1, wherein the first arcuation edge and the second arcuation edge have a first arcuate surface and a second arcuate surface respectively.

5. The attachment lock as claimed in claim 4, wherein when the pair of locking parts move into the coupling orifice so as to be locked, at least one linear contact forms among the first arcuate surface of the first arcuation edge, the second arcuate surface of the second arcuation edge, and the peripheral wall of the accommodation chamber.

6. The attachment lock as claimed in claim 1, wherein the pair of locking parts are rotatably coupled in the body.

7. The attachment lock as claimed in claim 1, wherein the lock mechanism includes an abutting post configured to abut against and to expand the pair of locking parts.

8. The attachment lock as claimed in claim 1, wherein the lock mechanism is a key lock mechanism.

9. The attachment lock as claimed in claim 7, wherein the lock mechanism is a key lock mechanism.

10. The attachment lock as claimed in claim 1, wherein the lock mechanism is a combination lock mechanism.

11. The attachment lock as claimed in claim 7, wherein the lock mechanism is a combination lock mechanism.
